(19) United States
(12) Patent Application Publication
(10) Pub. No.: US 2004/0090083 A1
(43) Pub. Date: May 13, 2004

(54) Method for the automatic operation of a vehicle door and device for carrying out said method

(76) Inventors: Ingo Greuel, Munchen (DE); Dietmar Orth, Karlsfeld (DE); Holger Schiffer, Meersbusch (DE); Bernd Ulbricht, Markt Indersdorf (DE)

Correspondence Address: Liniak Berenato Longacre & White, Suite 240, 6550 Rock Spring Drive, Bethesda, MD, 20817, US

(21) Appl. No.: 10/473,776

(22) PCT Filed: Apr. 9, 2002
(86) PCT No.: PCT/EP02/03895

(30) Foreign Application Priority Data
Apr. 10, 2001 (DE) 10117935.9

(51) Int. Cl. B60J 5/00

(52) U.S. Cl. 296/146.4

(57) ABSTRACT

The invention relates to a method for the automatic operation of a vehicle door (1), in particular a side door, or a rear hatch of a motor vehicle, from a first to a second position, by means of a drive (5; 26), connected to a controller (6), which acts on the vehicle door (1), by means of at last one transfer element (12; 30). The invention further relates to a device for carrying out said method. According to the invention, an automatically operated vehicle door (1) in the first position thereof, may be simply swung into the second position thereof at the same speed, even with differing street inclinations where the vehicle is standing, whereby, after activating the drive (5), the speed of the relevant vehicle door (1) is measured within a given angular range and compared with a set value curve. So long as the measured actual value for speed of the vehicle differs from the given set value curve, the speed of the door is changed until the speed as given by the set value curve is achieved.

The invention relates to a method for automatically actuating a vehicle door, in particular a side door or a tailgate of a motor vehicle, from a first into a second position, according to the features of the precharacterizing clause of claim 1. The invention is furthermore concerned with a device for carrying out the method.

Any part of a vehicle which can be pivoted in order to close an opening is referred to collectively as vehicle door in the context of this invention. The vehicle door can therefore be either a side or rear door or else a trunk lid, an engine hood, a roof flap or the like.

Motor vehicles having automatically actuable tailgates have already been proposed. In these cases, the tailgate is closed or opened by, for example, the vehicle driver by means of a corresponding actuation of the switch provided in the instrument panel or of a radio-operated switch. For this purpose, the switching signal produced by the switch acts on an electronic control device which, for its part, produces electric control signals in order to activate an electric motor which then, for its part, drives a shaft which acts via transmission elements on the tailgate and pivots the latter.

A disadvantage of these known vehicles is that the vehicle door is closed at different speeds, depending on the inclination of the underlying surface on which the vehicle is standing, because the mass center of gravity of the vehicle door, which is displaced in relation to the axis of rotation of the tailgate, and therefore the torque acting on the vehicle door due to the gravitational force can greatly change. However, this causes the load on the drive for actuating the vehicle door to differ greatly, which leads to a change in the closing speed and is frequently undesirable. In particular in the case of motor vehicles which are standing on a slope and whose particular tailgate is facing the slope summit, [lacuna] are frequently only relatively slowly closed by the drive.

In the case of motor vehicles in which the electric motor only pivots the vehicle door during a first pivoting range and is subsequently then switched off or uncoupled, if the slope position is unfavorable the vehicle door may not be able to reach its closed position at all.

The invention is based on the object of specifying a method and a device for carrying out the method, with the aid of which the automatically actuable vehicle door of a motor vehicle can be pivoted at the same speed from a first into a second position even if the road on which the corresponding motor vehicle is standing has a different inclination.

This object is achieved according to the invention by the features of claim 1 in respect of the method and by the features of claim 12 in respect of the device. Further particularly advantageous refinements of the invention are disclosed in the subclaims.

The invention is essentially based on the concept of measuring, after the drive is activated, the speed at which the particular vehicle door is pivoted from its first into its second position, continuously or at predetermined time intervals and of making a comparison with a predetermined, angle-dependent desired value curve. If the measured actual value of the vehicle door deviates from the desired value curve, regulation of the current is used to bring the rotational speed of the motor and therefore the speed of the vehicle door to the predetermined desired value, so that said door is moved into its second position at the predetermined speed.

The method according to the invention furthermore has the advantage of also compensating for other effects on the elements of the drive, such as frictional forces, spring forces, supply voltages, temperature changes, wear of the individual elements, etc.

In order to measure the speed of the vehicle door, it has proven advantageous, in particular if an electromechanical drive is used, if the rotational speed of the shaft driven by the motor for pivoting purposes (for example, the output shaft of the motor, shaft of an intermediate gear assembly or output shaft of a coupling arranged between the motor or intermediate gear assembly and transmission elements) is measured. In this case, the measurement can be undertaken, for example, by using a potentiometer, a magnet sensor (Hall sensor) or an optical sensor which scans a code on the shaft.

Using the abovementioned sensors, the actual speed of the vehicle door is therefore not measured directly, but rather the chronological profile of the movement of a driving element is detected. The control device then uses these values to determine the actual speed of the vehicle door and compares it with the desired speed predetermined for the particular angular position of the vehicle door in order, if appropriate, to correspondingly adapt the motor current.

In order, in particular, to ensure that the vehicle door is securely closed against the pressure of the door seals, it has furthermore proven expedient if the vehicle door is moved with the device according to the invention into a closed position. After this position is reached, the drive of the device according to the invention is then switched off or decoupled, and a motor-powered closing aid which is known per se (cf., for example, DE 199 10 031 A1) and is arranged in the door lock or in the region of the door lock is activated. Said closing aid displaces the closing bolt or the closing shackle and thereby draws the vehicle door counter to the pressure of the door seal into its closed end position.

Further details and advantages of the invention emerge from the following exemplary embodiments which are explained with reference to figures, in which:

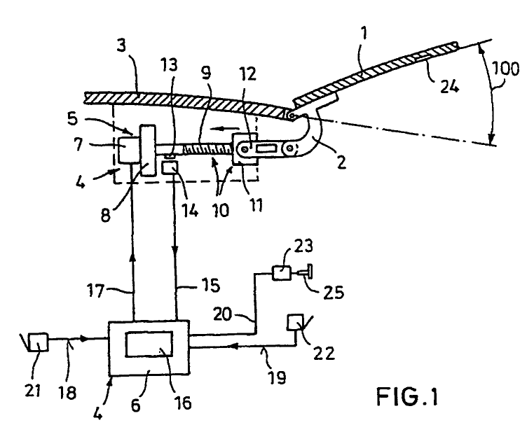

FIG. 1 shows the schematic view of a tailgate in the region of the roof support of a corresponding motor vehicle with an electromechanical drive and a control device for this drive;

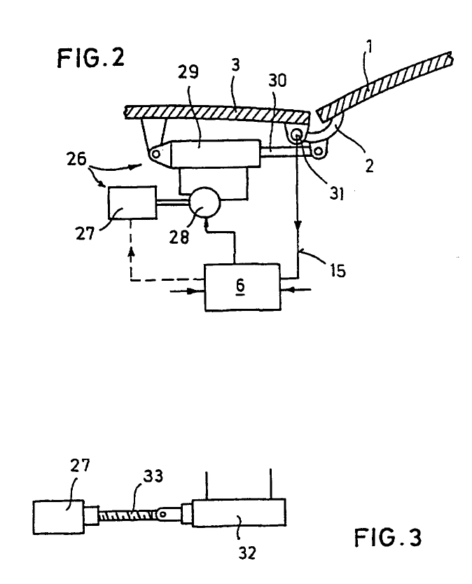

FIG. 2 shows a view corresponding to FIG. 1 with a hydraulic drive, and

FIG. 3 shows the development of a part of the hydraulic drive illustrated in FIG. 2.

In FIG. 1, 1 indicates the tailgate of a motor vehicle which is arranged on the roof support 3 of the corresponding vehicle in a manner such that it can be pivoted via hinge straps 2. The tailgate 1 is in its open position.

FIG. 1 furthermore illustrates a device 4 according to the invention which essentially comprises a drive 5 and a control device 6 connected to the drive 5. The drive 5 comprises an electric motor 7 which uses a coupling 8 to drive the spindle 9 (shaft) of a spindle drive 10, the spindle nut 11 of which acts on the hinge strap 2 via a transmission element 12.

A permanent magnet 13 is fastened to the spindle 9 and interacts with a Hall sensor 14 which is connected via an electric line 15 to the control device 6, which contains a microprocessor 16. In addition, the control device 6 is connected via electric lines 17-20 to the electric motor 7, a switch 21 for initiating the automatic closing of the tailgate 1, a switch 22 for switching off the motor 7 of the drive 5 as soon as the tailgate 1 has reached a first closed position, and a motor-powered closing aid 23.

If the tailgate 1 is to be closed, the electric motor 7 is activated by actuation of the switch 21 via the control device 6. Said electric motor uses the coupling 8 to rotate the spindle 9 of the spindle drive 10, the spindle nut 11 of which then pivots the tailgate 1 downward by axial displacement via the transmission element 12 and the hinge strap 2.

In this case, the corresponding magnetic pulses is [sic] detected at the same time with the aid of the Hall sensor 14. The sensor values are fed via the line

to the control device 6, the microprocessor 16 of which then determines a rotational-speed value or the actual closing speed of the vehicle door as soon as the vehicle door 1 has been pivoted about a pivoting angle within a predetermined pivoting-angle range 100.

The particular rotational-speed value or the closing speed determined therefrom is compared with a corresponding, angle-dependent desired value. If the measured rotational-speed value lies below or above the desired value, then, with the aid of the control device 6 via the line 17, an increase or reduction in the motor current takes place, with the result that the latter increases or reduces the rotational speed of the spindle 9 and therefore the actual speed of the tailgate 1 to the predetermined desired value.

If the tailgate 1 has reached its first closed position, i.e. as soon as a closing latch, which is arranged in the tailgate 1 and is indicated by 24, has surrounded a closing bolt 25 which is mounted displaceably in the vehicle body, the switch 22 which is connected to the control device 6 via the line 19 causes the electric motor 7 to be switched off.

At the same time, the control device 6 is used to activate the motor-powered closing aid 23 which then displaces the closing bolt 25 toward the inside of the vehicle in a manner known per se and therefore draws the vehicle door into its end position.

The invention is no way restricted to the above-described exemplary embodiment. Thus, for example, a hydraulic drive may also be used as the drive. A corresponding exemplary embodiment is reproduced in FIG. 2:

In this case, 1 again indicates the tailgate, 2 the hinge strap, 3 the roof support of the corresponding vehicle and 6 the electronic control device. The drive is provided with the reference number 26 and comprises a pump 28, which is driven by an electric motor 27 and has a valve device (not illustrated) connected downstream, and a thrust motor 29, the piston rod 30 of which acts on the hinge strap 2. The activation of the valve device (not illustrated separately) takes place, for example, with the aid of the control device 6.

In this case, the pivoting path of the tailgate 1 is measured by a potentiometer 31 which detects the rotational movement of the hinge strap 2. The values measured by the sensor are transmitted via the line 15 to the control device 6 for evaluation and the actual speed of the tailgate 1 is determined there. The regulating procedure then takes place in accordance with the procedure described in conjunction with the preceding exemplary embodiment. In this case, instead of the valve of the pump 28, the electric motor 27 may also be regulated (the corresponding connection between the control device and the electric motor is illustrated by dashed lines in FIG. 2).

Instead of measuring the pivoting path with a potentiometer, use may also be made of an optical displacement transducer which scans a code on the piston rod or on a further transmission element connected to the piston rod.

FIG. 3 illustrates an exemplary embodiment in which the pump (indicated in FIG. 2 by 28) for the hydraulic drive is replaced by a cylinder 32 with a piston (not illustrated) (master cylinder) which can be displaced by the electric motor 27 with a spindle drive 33 connected downstream.

### List of Reference Numbers

1 tailgate, vehicle door

2 Hinge strap

3 Roof support

4 Device

5 Drive

6 Control device

7 Electric motor, motor

8 Coupling

9 Shaft, spindle

10 Spindle drive

11 Spindle nut

12 Transmission element

13 Permanent magnet

14 Sensor, Hall sensor

15 Line

16 Microprocessor

17-20 Lines

21 Switch

22 Switch

23 Closing aid

24 Closing latch

25 Closing bolt

26 Drive

27 Electric motor

28 Pump

29 Thrust motor

30 Piston rod, transmission element

31 Potentiometer, sensor

32 Cylinder

33 Spindle drive

100 Pivoting-angle range

1. A method for automatically actuating a vehicle door (1), in particular a side door or a tailgate of a motor vehicle, from a first into a second position by means of a drive (5; 26) which is connected to a control device (6) and acts on the vehicle door (1) via at least one transmission element (12; 30), characterized
in that, after the drive (5; 26) is activated, the speed at which the vehicle door (1) is pivoted from its first into its second position is measured continuously or at predetermined time intervals within a predetermined pivoting-angle range (100) of the vehicle door (1) with the aid of at least one sensor (14; 31),
in that the actual speed of the vehicle door (1) is compared with a predetermined, angle-dependent desired value curve, and
in that, if the actual speed deviates from the desired value curve, the control device (6) is used to regulate the drive (5; 26) to bring the speed of the vehicle door (1) to the predetermined desired value, so that said vehicle door is moved into its second position at the speed predetermined by the desired value curve.

2. The method as claimed in claim 1, characterized in that an electromechanical drive is used as the drive (5).

3. The method as claimed in claim 1, characterized in that a hydraulic drive is used as the drive (26).

4. The method as claimed in one of claims 1 to 3, characterized in that, in order to measure the actual speed of the vehicle door (1), the rotational speed of a shaft (9) driven by the drive (5) to pivot the vehicle door is measured.

5. The method as claimed in one of claims 1 to 3, characterized in that in order to measure the actual speed of the vehicle door (1), the rotational angle of a hinge strap (2) of the vehicle door (1) is measured.

6. The method as claimed in claim 4 or 5, characterized in that a potentiometer (31) is used to measure the rotational speed or rotational angle of the shaft or of the hinge strap.

7. The method as claimed in claim 4, characterized in that a Hall sensor (14) is used to measure the rotational speed of the shaft, said sensor measuring the changes of the magnetic field of a permanent magnet (13) arranged on the shaft (9).

8. The method as claimed in claim 4, characterized in that an optical sensor which scans a code on the shaft is used to measure the rotational speed of the shaft.

9. The method as claimed in one of claims 1 to 3, characterized in that, in order to measure the actual speed of the vehicle door (1), the displacement of a transmission element (30) which can be displaced to pivot the vehicle door (1) is measured.

10. The method as claimed in claim 9, characterized in that, in order to measure the displacement of the transmission element, an optical sensor which scans a code on the transmission element is used.

11. The method as claimed in one of claims 1 to 10, characterized in that the vehicle door (1) is moved by the drive (5; 26) into a first closed position in which the lock elements of the vehicle door and vehicle body engage in each other, in that the drive (5; 26) is switched off or decoupled, and in that the vehicle door (1) is then drawn by means of a motor-powered closing aid (23) into a second closed position.

12. A device for carrying out the method as claimed in one of claims 1 to 11, characterized
in that at least one sensor (14; 31) is provided which produces electrical signals which are representative of the speed of the vehicle door (1) moving from its first into its second position,
in that the sensor (14; 31) is connected to a control device (6) which contains a microprocessor (16) which determines the speed of the vehicle door (1) in each case from the measured sensor signals within a predetermined pivoting-angle range (100) and compares these actual speed values with a predetermined, angle-dependent desired value curve, and
in that the control device (6) is operatively connected to the drive (5; 26) in such a manner that, if the actual speed deviates from the desired value curve, the drive (5; 26) brings about a change in the speed of the vehicle door (1) until the latter has reached the desired value predetermined by the desired value curve.

13. The device as claimed in claim 12, characterized in that the drive (5) is an electromechanical drive.

14. The device as claimed in claim 13, characterized in that the electromechanical drive (5) comprises an electric motor (7) which drives a shaft (9) which acts on the vehicle door (1) via transmission elements (12), and in that the control device (6) is connected to the electric motor (7) in order to regulate the drive.

15. The device as claimed in claim 12, characterized in that the drive (26) is a hydraulic drive.

16. The device as claimed in claim 15, characterized in that the hydraulic drive (26) comprises an electric motor (27), a pump (28) and a thrust motor (29), the piston rod (30) of which acts on the vehicle door (1) directly or via a further transmission element connected to the piston rod (30), and in that the control device (6) acts on the electric motor (27) or on a valve device connected to the pump (28) in order to regulate the drive (26).

17. The device as claimed in claim 14, characterized in that the sensor (14) is a sensor for measuring the rotational speed of the shaft (9) which is driven by the motor (7) in order to close the vehicle door (1).

18. The device as claimed in claim 17, characterized in that a permanent magnet (13) is arranged on the shaft (9) whose rotational speed is to be measured, and in that the sensor is a Hall sensor (14) which measures the changes of the magnetic field of the permanent magnet (13) arranged on the shaft (9).

19. The device as claimed in one of claims 12 to 17, characterized in that the sensor is an optical sensor which scans a code on a shaft (9) or on a transmission element (30) which is being displaced.

20. The device as claimed in one of claims 12 to 17, characterized in that the sensor is a potentiometer (31).

21. The device as claimed in one of claims 12 to 20, characterized in that the control device (6) is electrically connected to a motor-powered closing aid (23) which can be activated by the control device (6) as soon as the vehicle door (1) has reached its first closed position.
